(19) United States
(12) Patent Application Publication
(10) Pub. No.: US 2003/0051016 A1
(43) Pub. Date: Mar. 13, 2003

(54) Address management system, anycast address setting apparatus, communication terminal, information storage device, address management method, and computer program

(76) Inventors: Yutaka Miyoshi, Kanagawa (JP); Tsutomu Miyauchi, Kanagawa (JP)

Correspondence Address: Bell, Boyd & Llyod LLC, P.O. Box 1135, Chicago, IL, 60690, US

(21) Appl. No.: 10/214,256

(22) Filed: Aug. 7, 2002

(30) Foreign Application Priority Data
Aug. 7, 2001 (JP) P2001-239147

(51) Int. Cl. G06F 15/177

(52) U.S. Cl. 709/222; 710/13

(57) ABSTRACT

In an improved address management system using portable storage media, an anycast address is supplied via a portable storage medium so that the anycast address can be used by various communication terminals. When a communication terminal is replaced with a new one, the same anycast address can be used for the new communication terminal, and thus IPv6-based communication can be employed in a service such as telephone service in which high availability is required. Furthermore, an anycast address can be used as an identifier uniquely identifying a user. Thus, this technique provides an infrastructure which is very useful, in particular, in applications in which service is provided differently depending on customers. Furthermore, an anycast address can be moved, copied, and returned. This makes it possible for a number of users or devices to use the same anycast address in a very efficient manner.

### BACKGROUND OF THE INVENTION

The present invention relates to an address management system, an anycast address setting apparatus, a communication terminal, an information storage device, an address management method, and a computer program. More particularly, the present invention relates to an address management system and method, and a computer program, which make it possible to easily and reliably transfer an interface ID according to IPv6 (Internet Protocol version 6) between devices. In recent years, portable personal computers and portable telephones have become very popular. Many users carry their own small-sized communication terminal to process and communicate information via a network at remote locations such as outdoor locations, offices or the like.

In the Internet, IP (Internet Protocol) is used as a communication protocol. At present, IPv4 is one of the most popular versions of the IP. In IPv4, a 32-bit address (IP address) is used to indicate an originating/destination device. In each Internet communication, a 32-bit IP address, called a global IP address, is uniquely assigned to each originating/destination device such that each originating/destination device can be identified by an assigned IP address. However, because the Internet is continuously expanding, the IPv4 address space is becoming deficient. That is, the available number of global addresses is not large enough to satisfy current Internet requirements. To solve the above problem, the IETF (the Internet Engineering Task Force) has proposed a new version of the IP called IPv6 (Internet Protocol version 6) to expand the IP address space from 32 bits to 128 bits.

IPv6 is a successor to IPv4 and has an address format shown in FIG. 1. Each IPv6-based address consists of 128 bits including lower-order bits used to indicate an interface ID (i.e., IEEE802) serving as a node identifier for uniquely identifying each node on a subnet. Higher-order bits are used to indicate a network prefix serving as a location identifier indicating a subnetwork which is connected to a node. This means that terminal devices belonging to the same subnetwork have the same network prefix indicated by the higher-order bits of an IPv6 address.

In IPv6, a device manufacturer is allowed to assign an interface ID indicated by lower-order bits because packet transmission is performed only on the basis of a prefix and a subnet number. More precisely, a part of an interface ID number is used as a manufacturer identifier, and the remaining part is allowed to be freely used by the manufacturer. Thus in IPv6, unlike IPv4, the interface ID, which is a part of an IPv6 address, is allowed to be freely defined and used. For example, interface ID's can be related to user ID's so that customer information is related via interface ID's to devices sold.

However, in practice, the correspondence between interface ID's and customers is not fixed but variable. For example, a change can occur in the correspondence when a user replaces an existing terminal with a newly purchased terminal. The changes in the correspondence between the interface ID's and the customers can adversely affect applications such as an IP telephone system in which correspondence between users and IP addresses is important. For example, in the case of the IP telephone system, data indicating the correspondence between general names of parties and IP addresses of communication devices is stored according to the address resolution protocol, and the telephone service is provided in accordance with the correspondence data.

However, if a change occurs in the correspondence between the interface ID's and the users because of a customer's behavior such as replacing a terminal with a newly purchased terminal, it becomes impossible to communicate with the new terminal until the data is modified to reflect the change. Communication becomes impossible to the new terminal because, although packet transmission is performed only on the basis of a prefix and a subnet number, an IPv6-based device at the receiving end determines whether to accept a received packet, in accordance with an entire IPv6 address including an interface ID.

Such a situation should be avoided in applications such as telephone systems in which very high availability is required. Thus, conventionally, it is difficult to apply the IPv6 to applications such as telephone systems because these systems require very high availability and also because a change can occur in the correspondence between interface ID's and customers.

The present invention solves the problems described above. More specifically, the present invention provides an address management system, an anycast address setting apparatus, a communication terminal, an information storage device, an address management method, and a computer program, which an IPv6 anycast mechanism is dealt with as an ID uniquely assigned to a user thereby providing a highly convenient environment which allows the individual user to receive specific service.

In the IPv6, three different types addresses are defined. The addresses are unicast, anycast, and multicast addresses. A unicast address is an identifier indicating a single interface. When a unicast address is used, a packet is transmitted to a single interface indicated by the unicast address. An anycast address is an identifier indicating a set including a number of interfaces. When an anycast address is used, a packet is transmitted to an interface which is determined, by distance measurement based on the path control protocol, to be at a nearest location. A multicast address is an identifier also indicating a set including a number of interfaces. However, in the case of the multicast address, a packet is transmitted to all interfaces indicated by the multicast address.

In an anycast service, a service request is issued to a number of terminals, and one or more terminals perform a service in response to the service request. This is similar to a pilot number service in a telephone system, wherein an IPv6 anycast address corresponds to a pilot number.

If an anycast address is dealt with as an address uniquely assigned to a user, it becomes possible to assign the same address to all devices of the user. In this case, when a device is replaced, the address does not need to be changed. Another great advantage of this technique is that anycast-based service can also be achieved.

Another advantage of the present invention to provide an address management system and method, and a computer program, in which a portable storage medium having a capability of protecting a digital content is used to set an ID, wherein the setting of the ID can be easily performed and fraudulent use of the ID can be prevented.

### SUMMARY OF THE INVENTION

In one embodiment of the present invention, an address management system set in a communication terminal for performing communication processing is provided which includes a communication terminal in which an address is to be set; a portable storage medium attached to the communication terminal for storing an anycast address; and an anycast address setting apparatus for issuing anycast address information associated with the address to be set in the communication terminal, wherein the anycast address setting apparatus outputs the anycast address information to the portable storage medium, upon the successful authentication of the portable storage medium. Upon receiving the anycast address information, the portable storage medium stores the received anycast address information into a memory disposed in the portable storage medium. Then, the portable storage medium outputs the anycast address information to the communication terminal upon the successful authentication between the portable storage medium and the communication terminal connected to the portable storage medium. The communication terminal sets an address included in the anycast address information received from the portable storage medium such that the address functions as an anycast address assigned to the communication terminal.

In one aspect of this embodiment, the address included in the anycast address information is an interface ID indicated by lower-order bits of an address structure defined in IPv6.

In another aspect of this embodiment, the anycast address setting apparatus outputs the anycast address information to be stored in the portable storage medium with a digital signature generated by the anycast address setting apparatus, upon the successful authentication of the portable storage medium. When the portable storage medium receives the anycast address information and the digital signature, the portable storage medium stores the anycast address information and the digital signature into the memory of the portable storage medium upon the verification of the digital signature.

In a further aspect of this embodiment, the anycast address information stored in the portable storage medium includes additional attribute information including usage condition information and also a digital signature for verifying whether tampering of the anycast address has occurred or not.

In another aspect of this embodiment, the anycast address information stored in the portable storage medium includes additional attribute information including usage condition information, and, when the attribute information changes, a modified attribute and a digital signature are generated by a device which generated the modified attribute and are stored with the modified attribute in the portable storage medium.

In a further aspect of this embodiment, the anycast address setting apparatus performs an operation of moving and/or copying an anycast address information such that anycast address information received from a first portable storage medium is output to a second portable storage medium.

Furthermore, the anycast address setting apparatus moves and/or copies anycast address information such that anycast address information received from a first portable storage medium is output to the second portable storage medium, upon the verification of a digital signature attached to the anycast address information received from the first portable storage medium, which proves that the anycast address information has not been tampered with.

In another aspect of this embodiment, the portable storage medium outputs, to the communication terminal, the anycast address information and a digital signature generated by the portable storage medium, when authentication is successfully established between the portable storage medium and the communication terminal. When the communication terminal receives the anycast address information and the digital signature, the communication terminal stores the anycast address information in the memory of the communication terminal such that the anycast address functions as an anycast address of the communication terminal upon the verification of the digital signature.

In a further aspect of this embodiment, the anycast address setting apparatus receives anycast address information with a digital signature attached thereto from the portable storage medium and cancels the anycast address information by deleting associated data from an anycast address information management database upon the verification of the digital signature, which proves that the anycast address information has not been tampered with.

In another embodiment of the present invention, an anycast address setting apparatus issues anycast address information associated with an address usable as an address of a communication terminal, wherein the anycast address setting apparatus outputs anycast address information to a portable storage medium into which the address is to be stored upon the successful authentication between the anycast address setting apparatus and the portable storage medium.

In one aspect of this embodiment, the address included in the anycast address information is an interface ID indicated by lower-order bits of an address structure defined in IPv6.

In another aspect of this embodiment, when the anycast address setting apparatus outputs anycast address information to the portable storage medium into which the anycast address is to be stored, the anycast address setting apparatus attaches a digital signature to the anycast address information.

In a further aspect of this embodiment, when the anycast address setting apparatus outputs anycast address information to the portable storage medium, the anycast address setting apparatus adds, to the anycast address information, attribute information including usage condition information and a digital signature attached thereto for verifying whether the anycast address information has been tampered with.

In another aspect of this embodiment, the anycast address setting apparatus moves and/or copies an anycast address information such that the anycast address information received from a first portable storage medium connected to the anycast address setting apparatus is output to a second portable storage medium.

In a further aspect of this embodiment, the anycast address setting apparatus moves and/or copies an anycast address information such that anycast address information received from a first portable storage medium connected to the anycast address setting apparatus is output to a second portable storage medium, upon the verification of a digital signature attached to the anycast address information received from the first portable storage medium. The verification of the digital signature proves that the anycast address information has not been tampered with.

In another aspect of this embodiment, the anycast address setting apparatus receives anycast address information with a digital signature from the portable storage medium and cancels the anycast address information by deleting associated data from an anycast address information management database, upon the verification of the digital signature.

According to a further embodiment of the present invention, a communication terminal receives anycast address information including an address usable as an address of the communication terminal from a portable storage medium attached to the communication terminal upon the successful authentication between the portable storage medium and the communication terminal. The communication terminal stores the received anycast address information into a memory of the communication terminal such that the address functions as an anycast address of the communication terminal upon the verification of a digital signature attached to the anycast address information.

In one aspect of this embodiment, the address included in the anycast address information is an interface ID indicated by lower-order bits of an address structure defined in IPv6.

According to another embodiment of the present invention, an information storage device which is attachable and detachable to and from a communication terminal and capable of processing data. Anycast address information including an address usable as an address of the communication terminal is stored in a memory, and the anycast address information is read from the memory of the information storage device and output to the communication terminal upon the successful authentication between the information storage device and the communication terminal.

In one aspect of this embodiment, after the information storage device reads the anycast address information from the memory and outputs it to the communication terminal, the information storage device deletes the anycast address information from the memory of the information storage device.

According to another embodiment of the present invention, an address management method for managing an address is set in a communication terminal for performing communication processing. The method outputs anycast address information from an anycast address setting apparatus to a portable storage medium, upon the successful authentication between the anycast address setting apparatus and the portable storage medium; stores the received anycast address information into a memory disposed in the portable storage medium upon receiving the anycast address information; outputs the anycast address information from the portable storage medium to the communication terminal, upon the successful authentication between the portable storage medium and the communication terminal; and sets an address included in the anycast address information received from the portable storage medium such that the address functions as an anycast address of the communication terminal.

In one aspect of this embodiment, the address included in the anycast address information is an interface ID indicated by lower-order bits of an address structure defined in IPv6.

In another aspect of this embodiment, the anycast address setting apparatus outputs the anycast address information to be stored in the portable storage medium together with a digital signature generated by the anycast address setting apparatus, when the portable storage medium successfully passes authentication, and when the portable storage medium receives the anycast address information and the digital signature, the portable storage medium stores the anycast address information and the digital signature into the memory of the portable storage medium, upon the verification of the digital signature.

In a further aspect of this embodiment, the anycast address information stored in the portable storage medium includes additional attribute information including usage condition information and a digital signature for verifying whether the anycast address information has been tampered with.

In another aspect of this embodiment, the anycast address information stored in the portable storage medium includes additional attribute information including usage condition information and, when the attribute information is changed, a modified attribute and a digital signature are generated and stored in the portable storage medium.

In a further aspect of this embodiment, the anycast address setting apparatus moves and/or copies anycast address information such that anycast address information received from a first portable storage medium connected to the anycast address setting apparatus is output to a second portable storage medium.

In another aspect of this embodiment, the anycast address setting apparatus moves and/or copies an anycast address information such that anycast address information received from a first portable storage medium connected to the anycast address setting apparatus is output to a second portable storage medium, upon the verification of a digital signature attached to the anycast address information received from the first portable storage medium.

In a further aspect of this embodiment, the portable storage medium outputs, to the communication terminal, the anycast address information with a digital signature generated by the portable storage medium, upon the successful authentication between the portable storage medium and the communication terminal. When the communication terminal receives the anycast address information and the digital signature, the communication terminal stores the anycast address information in the memory of the communication terminal such that the anycast address functions as an anycast address of the communication terminal upon the verification of the digital signature.

In another aspect of this embodiment, the anycast address setting apparatus receives anycast address information with a digital signature from the portable storage medium and cancels the anycast address information by deleting associated data from an anycast address information management database, upon the verification of the digital signature.

According to another embodiment of the present invention, a computer program causes a computer system to execute an address issuing process for issuing an address to be set in a communication terminal. The computer program performs authentication between an anycast address setting apparatus for issuing anycast address information including an address usable as an address of the communication terminal and an information storage device into which the address is to be stored. The program then outputs the anycast address information from the anycast address setting apparatus to the information storage device, upon successful authentication. An information storage device verifies a digital signature associated with the anycast address information and stores the anycast address information into a memory when the verification indicates that no tampering has been made.

According to a further embodiment of the present invention, a computer program is provided for causing a computer system to execute a communication process using an address set in a communication terminal. The computer program includes the steps of performing authentication between the communication terminal and a storage medium attached to the communication terminal outputs anycast address information from the storage medium to the communication terminals upon successful authentication between the storage medium and the communication terminal, and sets an address included in the anycast address information received from the storage medium such that the address functions as an anycast address of the communication terminal.

The computer program according to the present invention may be supplied to a general-purpose computer system capable of executing various program codes, by using a computer-readable storage medium in which the program is stored, a communication medium such as a network, a recording medium such as a compact disk (CD), an FD, or an MO. By providing such a program in a computer-readable form, it becomes possible for a computer system to execute a process in accordance with the program.

Additional features and advantages of the present invention are described in, and will be apparent from, the following detailed description of the invention and the Figures.

### BRIEF DESCRIPTION OF THE FIGURES

FIG. 1 is a schematic diagram showing a format of an IPv6 address.

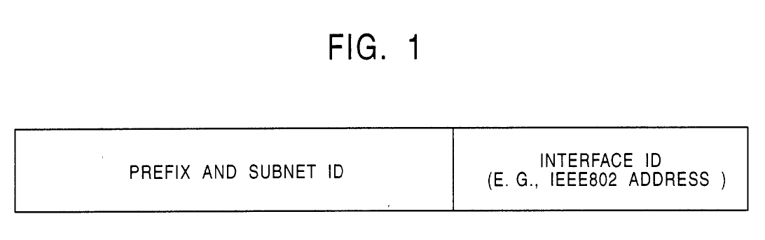

FIG. 2 is a schematic diagram schematically showing an address management system according to the present invention.

FIG. 3 is a schematic diagram showing configurations of a user terminal, a portable storage medium, and an anycast address setting apparatus, used in the address management system according to the present invention.

FIG. 4 is a schematic diagram showing a specific example of a process performed by the address management system according to the present invention.

FIG. 5 is a schematic diagram showing an example of a format of anycast address data stored in a portable storage medium used in the address management system according to the present invention.

FIG. 6 is a schematic diagram showing a sequence of processing steps of issuing a new anycast address performed in the address management system according to the present invention.

FIG. 7 is a schematic diagram showing a sequence of processing steps of authentication performed in the address management system according to the present invention.

FIG. 8 is a schematic diagram showing a sequence of processing steps of moving an anycast address performed in the address management system according to the present invention.

FIG. 9 is a schematic diagram showing a processing flow of verifying digital signatures and attributes performed in the address management system according to the present invention.

FIG. 10 is a schematic diagram showing a sequence of processing steps of copying an anycast address performed in the address management system according to the present invention.

FIG. 11 is a schematic diagram showing a sequence of processing steps of using an anycast address performed in the address management system according to the present invention.

FIG. 12 is a schematic diagram showing a sequence of processing steps of canceling an anycast address performed in the address management system according to the present invention.

### DETAILED DESCRIPTION OF THE INVENTION

An address management system, an anycast address setting apparatus, a communication terminal device, an information storage device, and an address management method, according to the present invention, are described in detail below with reference to the accompanying drawings.

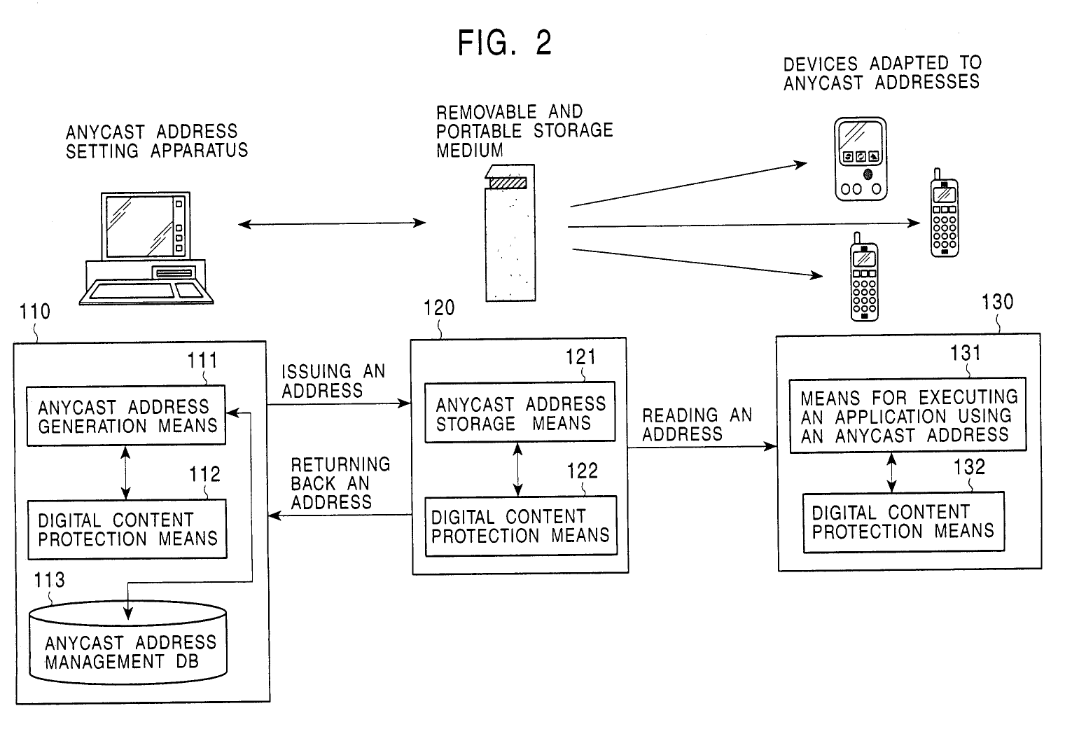

First, the outline of an address management system according to the present invention is described with reference to FIG. 2. In the address management system according to the present invention, data communication based on an address (IPv6 address) is performed by a communication terminal device having a communication capability, serving as a user terminal 130. Specific examples of such communication terminal devices include a cellular phone and a Personal Digital Assistant (PDA). These user terminals can be used in an application such as an IP telephone service which is performed on the basis of the correspondence between users and IP addresses.

The user terminal 130 is adapted such that a portable storage medium 120 including a flash memory or the like can be removably attached thereto. The portable storage medium 120 is an information storage device including a Central Processing Unit (CPU) and having a capability of performing, under the control of the CPU, information processing such as writing, deleting, and reading of information to/from a memory. By performing data transmission between the portable storage medium 120 and the anycast address setting apparatus 110, an interface ID indicated by lower-order bits of an IPv6 anycast address is received from the anycast address setting apparatus 110 and stored into the portable storage medium 120. By attaching the portable storage medium 120, in which the anycast address (interface ID) is stored, to the user terminal 130, it is possible for the user terminal 130 to use the anycast address stored in the portable storage medium 120 (interface ID) as an address of the user terminal 130.

In the present embodiment, it is assumed that an interface ID in an IPv6 address is used for an anycast-based service. Thus, hereinafter, the term “anycast address” is used to describe the “interface ID”. Note that, according to the original definition in the standard for IPv6, an “anycast address” denotes a whole IPv6 address including an interface ID, a subnet number, and a prefix, and thus the term “anycast address” used herein is different from that defined in the IPv6 standard. The term “anycast address” used herein can be defined more precisely as an interface ID for use in an anycast-based application. A specific example of such an interface ID for use in an anycast-based application is an interface ID stored in a portable storage medium 120.

The anycast address setting apparatus 110 communicates with the portable storage medium 120 to transmit an anycast address, which can be used by the user terminal 130, to the portable storage medium 120. If the portable storage medium 120 receives the anycast address, the portable storage medium 120 stores it in the memory.

The anycast address setting apparatus 110 includes anycast address generation means 111 for generating a new anycast address in response to a request received from the outside. Digital content protection part 112 detects an unauthorized anycast address or an anycast address that has been fraudulently tampered with. Depending on a situation, the digital content protection part 112 restores such an invalid anycast address. The digital content protection part 112 also performs mutual authentication in anycast information transmission with the portable storage medium 120, verification of a digital signature to check the validity of anycast information, checking of the limit on the number of times anycast information is copied, and checking of information about an issuer.

The anycast address setting apparatus 110 includes an anycast address management database 113 disposed inside or outside it. When the anycast address generation part 111 generates an anycast address, the anycast address generation part 111 refers to the anycast address management database 113 to confirm that the generated anycast address is not a duplicate of an existing anycast address. After the confirmation, the generated anycast address is issued to the portable storage medium 120 connected to the anycast address setting apparatus 110.

In addition to the issuing of an anycast address to a portable storage media 120, the anycast address setting apparatus 110 also takes back an anycast address from a portable storage medium 120 or deletes the anycast address stored in the portable storage medium 120, as required. Furthermore, the anycast address setting apparatus 110 stores and/or updates the data in the anycast address management database 113 in response to the issuing, taking back, or deleting of an anycast address.

The portable storage medium 120 includes anycast address storage part 121 formed of a flash memory or the like. The anycast address storage part 121 stores an anycast address allowed to be used by the user terminal 130 and also stores associated information such as a purchaser of the anycast address, a period of validity, the maximum allowable number of times copying is performed, and a digital signature. Two or more anycast addresses may be stored in the portable storage medium 120. Information associated with an anycast address (such as a holder of the address, a key value used in authentication, a service interface that can be accepted by the address) may also be stored together with the address in the portable storage medium 120.

In a process of transmitting anycast information between the portable storage medium 120 and the anycast address setting apparatus 110, digital content protection part 122 in the portable storage medium 120 performs protection processes such as mutual authentication, verification of a digital signature to check the validity of anycast information, checking of the limit on the number of times anycast information is copied, and checking of information about an issuer. Furthermore, while reading anycast information from the user terminal 130, the digital content protection part 122 performs mutual authentication, verification of a digital signature to check the validity of anycast information, checking of the limit on the number of times anycast information is copied, and checking of information about an issuer. The user terminal 130 is adapted such that the portable storage medium 120 including the flash memory or the like can be removably attached thereto. By attaching the portable storage medium 120 to the user terminal 130, the anycast address stored in the memory of the portable storage medium 120 is recognized and used as an address assigned to the user terminal 120, thereby allowing the user terminal 120 to perform IPv6-based communication. The user terminal 130 may also include a fixed IPv6 interface ID uniquely assigned to the user terminal 130 so that the user terminal 130 can also function as an ordinal IPv6-based device.

Part 131 for executing anycast-address-based applications, disposed in the user terminal 130, executes, for example, an application such as an IP telephone service or video telephone using an anycast address, on the basis of the correspondence between IP addresses and users.

In anycast information transmission between the user terminal 130 and the portable storage medium 120 in which the anycast address is stored, digital content protection part 132 disposed in the user terminal 130 performs mutual authentication, verification of a digital signature to check the validity of anycast information, checking of the limit on the number of times anycast information is copied, and checking of information about an issuer.

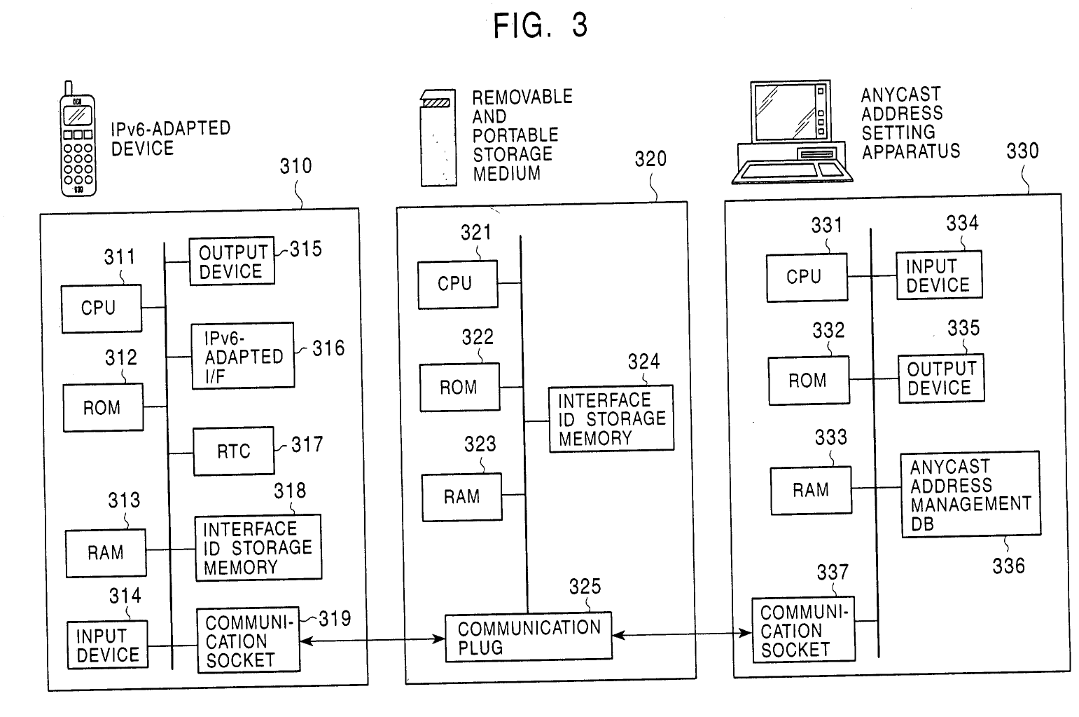

Referring to FIG. 3, hardware configuration is described below for the user terminal, the portable storage medium, and the anycast address setting apparatus. First, the hardware configuration of the user terminal 310 is described. A CPU 311 executes various operations and application programs. More specifically, the CPU 311 performs processing associated with the IPv6 upper-level protocol, deals with an inputting operation performed on the terminal by a human user, controls transmission of an anycast address between the user terminal 310 and the portable storage medium, and performs authentication required in the transmission process. A Read Only Memory (ROM) 312 stores a program executed by the CPU 311 and also stores data indicating fixed parameters used in computational operations. A Random Access Memory (RAM) 313 is used as a storage area or a working area, for storing a program executed by the CPU 311 and varying parameters used in the execution of the program.

An input device 314 is operated by a user to input various commands to the CPU 311. An output device such as an Liquid Crystal Display (LCD) 315 is used to display various kinds of information in the form of a text or an image.

An IPv6-adapted interface (I/F) 316 provides a communication channel which allows communication based on the IPv6 protocol. The IPv6-adapted interface 316 communicates with a router of a connected subnet to receive packet data or transmit data supplied from the CPU 311 or the RAM 313 after converting it into a packet form. An RTC 317 is used to measure an IPv6-communication time, when anycast address information is allowed within a predetermined limited period. The RTC is not necessarily required. The measured communication time is subtracted from the available usage time described in the anycast address used in the communication, and the resultant value is described in the form of a modified attribute (described later) in the anycast address information.

An IPv6-adapted interface ID storage memory 318 is a nonvolatile memory for storing an IPv6-adapted interface ID set in the user terminal. The data stored in the IPv6-adapted interface ID storage memory 318 is retained therein without being erased, even after electric power is turned off. Reading and writing of data from/to the IPv6-adapted interface ID storage memory 318 is controlled by the CPU 311. A communication socket 319 is a communication interface for interfacing with the portable storage medium.

Now, the configuration of the portable storage medium 320 is described. A CPU 321 executes various operations and application programs. More specifically, the CPU 321 controls reading/writing of data from/into the memory of the portable storage medium 320, encrypts and decrypts data, generates a digital signature, verifies a digital signature, controls transmission of an anycast address between the portable storage medium and the user terminal or the anycast address setting apparatus and performs authentication required in the transmission process. A ROM 322 stores a program executed by the CPU 311 and also stores data indicating fixed parameters used in computational operations. A RAM 323 is used as a storage area or a working area, for storing a program executed by the CPU 321 and varying parameters used in the execution of the program.

An interface ID storage memory 324 is a nonvolatile memory for storing an IPv6-adapted anycast address (interface ID) received from the anycast address setting apparatus. Reading, writing, and deleting of data to/from the interface ID storage memory 324 is controlled by the CPU 321.

A communication plug 325 serves as an interface for communicating with the user terminal to read an anycast address. The communication plug 325 also serves as an interface for communicating with the anycast address setting apparatus 330 to issue a new anycast address and return and delete an existing anycast address.

Now, the configuration of the anycast address setting apparatus 330 is described. A CPU 331 executes various operations and application programs. More specifically, the CPU 331 controls transmission of an anycast address between the anycast address setting apparatus 330 and the portable storage medium 320. A ROM 332 stores a program executed by the CPU 331 and also stores data indicating fixed parameters used in computational operations. A RAM 333 is used as a storage area or a working area, for storing a program executed by the CPU 331 and varying parameters used in the execution of the program.

An input device 334 is operated by a user to input various commands to the CPU 331. An output device such as a CRT or an liquid crystal display (LCD) 335, is used to display various kinds of information in the form of a text or an image.

An anycast address management database 336 is a database to manage the issuing of anycast addresses and stores data indicating the correspondence between users and anycast addresses and data indicating periods of validity. Although in this specific example, the anycast address management database 336 is located in the inside of the anycast address setting apparatus 330, an external network-accessible database may be used in common by a number of anycast address setting apparatuses.

A communication socket 337 serves as an interface for communicating with the portable storage medium 320 to issue a new anycast address and take back and delete an existing anycast address.

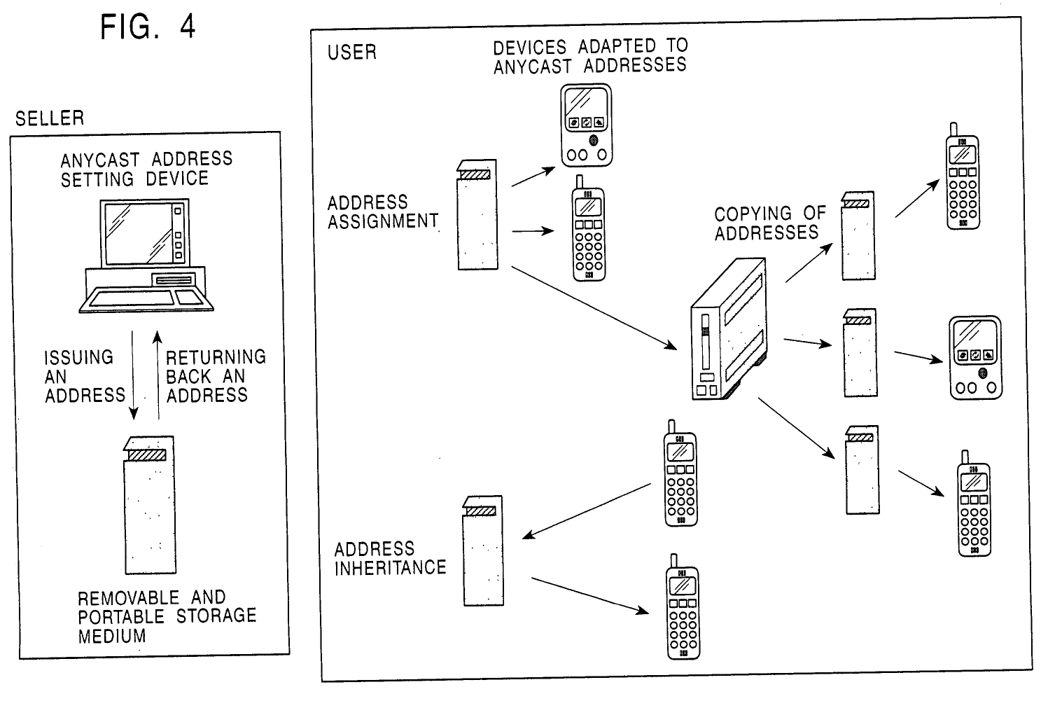

Referring to FIG. 4, a specific example of a process performed by the address management system according to the present invention is described below. Herein, it is assumed that a certain company distributes anycast addresses via a seller or an agent such that a customer can obtain a single anycast address. As described earlier, addresses (IPv6 addresses) are used by user terminals such as cellular phones or PDA's. By attaching a portable storage medium, in which an anycast address is stored, to a user terminal, it becomes possible for the user terminal to perform communication using the anycast address stored in the portable storage medium as the anycast address (interface ID) of the user terminal. By connecting a portable storage medium to the anycast address setting apparatus, it is possible to store, take back, or delete an anycast address.

As described above, each user terminal and each portable storage medium include their own digital content protection part, and data such as encryption key data needed in authentication or encryption/decryption performed in communication with another device. The digital content protection part is written in a ROM before each user terminal or portable storage medium is shipped.

A seller writes an anycast address into a portable storage medium and sells it thereby providing an anycast address to a user. An anycast address may also be provided to a user by writing it into a portable storage medium the user brought. Writing of anycast addresses- is performed by the anycast address setting apparatus. As described earlier with reference to FIGS. 2 and 3, after a portable storage medium, into which an anycast address is to be written, is connected to the anycast address setting apparatus, authentication is performed, and writing is performed if the authentication is successful.

At the seller, not only issuing of new anycast addresses, but also taking-back of anycast addresses stored in portable storage media and deleting of anycast addresses stored in portable storage media are performed.

Each seller possesses an anycast address setting apparatus. When a customer makes an order for an anycast address, the seller writes an anycast address into a portable storage medium of the customer, using the anycast address setting apparatus. When the anycast address is written, customer information is also written together with the anycast address into the portable storage medium. Furthermore, the same anycast address and the customer information are also stored in the anycast address setting apparatus. A specific example of a portable storage medium is a memory stick having a digital content protection capability.

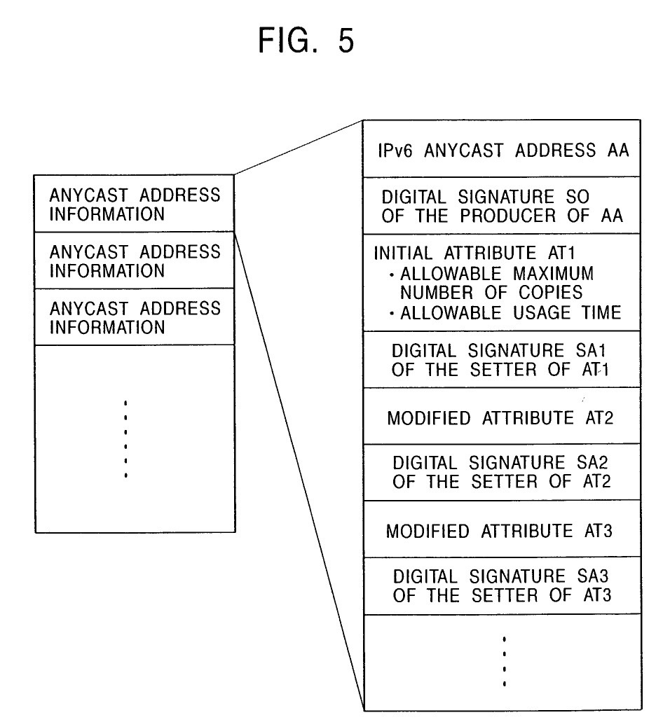

FIG. 5 shows an example of anycast address information stored in the anycast address setting apparatus and the portable storage medium. Anycast address information stored in the portable storage medium (S) is shown on the left-hand side of FIG. 5. As can be seen, a number of pieces of anycast address information can be stored in a single portable storage medium (S). On the right-hand side of FIG. 5, one piece of anycast address information is shown in more detail. The anycast information includes, at least, an IPv6 anycast address AA, a digital signature SO attached thereto by a producer of the IPv6 anycast address AA, an initial attribute AT1, and a digital signature SA1 attached thereto by a setter of the initial attribute AT1. Although in the specific example shown in FIG. 5, the anycast address information includes two attributes which are the available usage time and the maximum allowable number of copies, the items and the number of attributes may be properly selected by a setter of attributes.

More specifically, the attribute of the maximum allowable number of copies indicates the upper limit on the number of different portable storage media into which the IPv6 anycast address AA is allowed to be copied. The attribute of the available usage time indicates the time during which the IPv6 anycast address AA is allowed to be used. When IPv6 communication is performed, the time spent for the communication is measured by an RTC disposed in the user terminal, and the available usage time is updated by subtracting the measured time from the current value of the available usage time.

Attribute information is rewritten in response to using or copying of the IPv6 anycast address AA such that modified attributes AT2, AT3, . . . , and so on are created each time the IPv6 anycast address AA is used or copied, and the anycast address information is updated by adding the modified attributes one after another to the anycast address information. When a modified attribute is created, a digital signature is also created by a device which has created the modified attribute, that is, by a user terminal, a portable storage medium, or an anycast address setting apparatus, and the modified attribute is added together with the digital signature to the anycast address information. The anycast address information is transmitted among anycast address setting apparatuses, portable storage media, and user terminals. Each time a device receives anycast address information, the device checks a digital signature to determine whether or not the anycast address information has been tampered with.

A customer (user) can copy a purchased anycast address into a number of portable storage media to set the same anycast address in a number of devices serving as communication terminals the user possesses so that the anycast address is shared by those devices, and thus anycast-based service is shared by those devices. For example, if memory sticks in which the same anycast address is stored are attached to respective AV devices having a memory stick terminal, it becomes possible to practice anycast-based service among those AV devices. Copying of an anycast address may be performed using, for example, a PC, a cellular phone, a PDA, or the like.

If an anycast address has become unnecessary for a user, the user may bring to a seller a portable storage medium in which the unnecessary anycast address is stored, to have the unnecessary anycast address deleted from the portable storage medium using an anycast address setting apparatus. At the same time, the anycast address, customer information, and other associated information including data indicating the correspondence between the customer and the anycast address are also deleted from the anycast address management database 336 of the anycast address setting apparatus.

Of various processes performed by the system according to the present invention, those listed below are described in further detail.

(1) Issuing of an anycast address to a portable storage medium by an anycast address setting apparatus;

(2) Moving of an anycast address between different portable storage media via an anycast address setting apparatus;

(3) Copying of an anycast address between different portable storage media via an anycast address setting apparatus;

(4) Usage of an anycast address; and

(5) Returning (taking-back) of an anycast address

Each of those processes is described below in detail.

(1) Issuing of an Anycast Address to a Portable Storage Medium by an Anycast Address Setting Apparatus

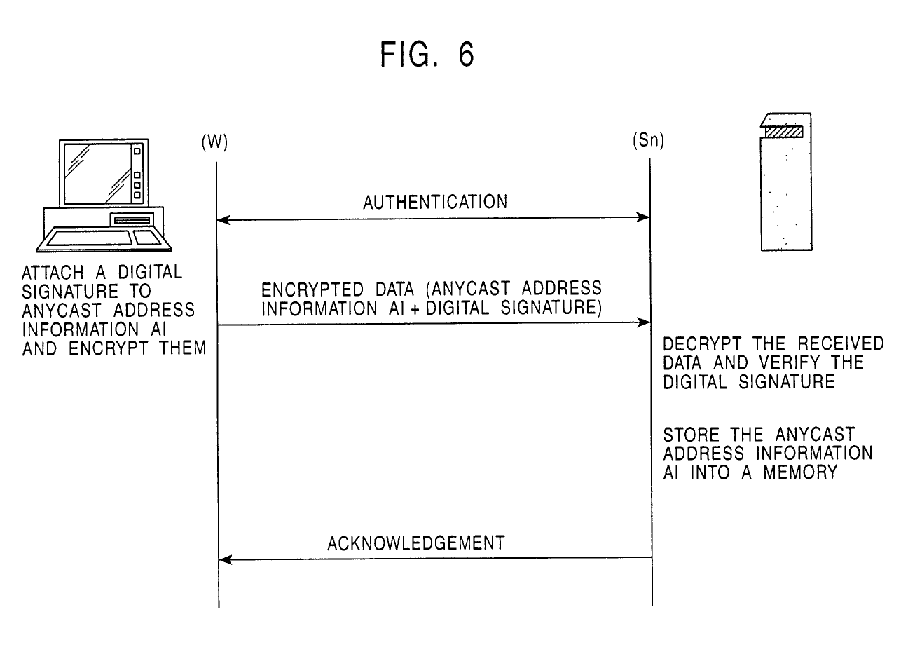

First, issuing of an anycast address to a portable storage medium by an anycast address setting apparatus is described. FIG. 6 shows a sequence of processing steps for issuing a new anycast address. Herein, a portable storage medium is assumed to be a new portable storage medium which has not been used at all after being shipped from a factory and which includes no anycast address stored therein.

First, the portable storage medium and the anycast address setting apparatus are connected to each other via a communication plug and a communication socket disposed in respective devices. After connecting them, authentication is performed to check whether the portable storage medium and the anycast address setting apparatus are both authorized devices. The authentication process can be accomplished using a public key authentication method, a common key authentication method, a combination of a digital watermark and Kerberos which is widely used in IPv4-based systems, or a method implemented on the basis of design according to interface specifications proposed by the Secure Digital Music Initiative (SDMI).

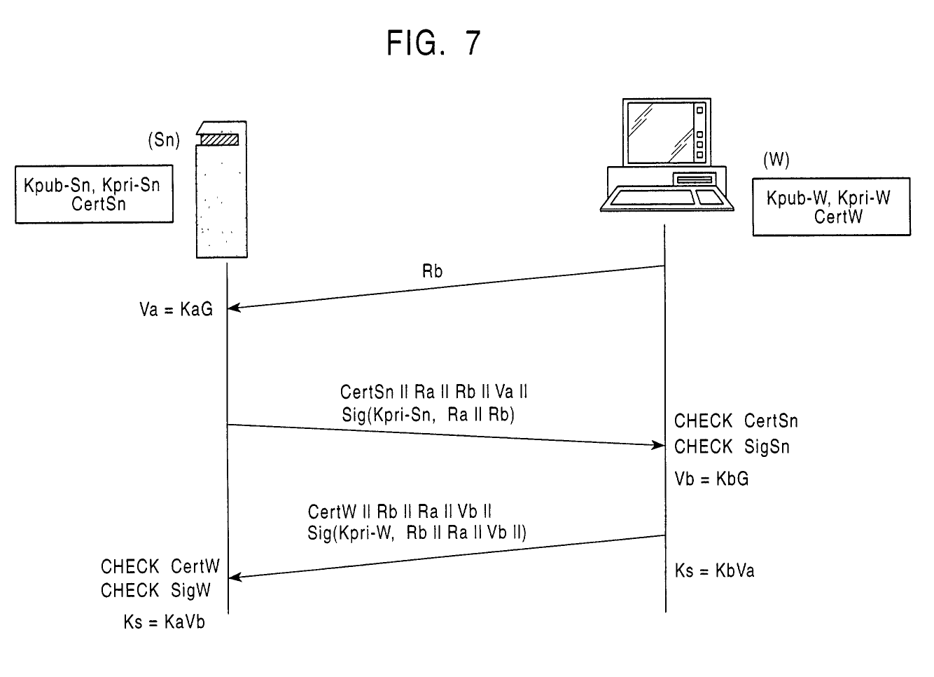

As an example, an authentication sequence using a public key is described below with reference to FIG. 7. To perform authentication based on the public key authentication method, the portable storage medium stores, in its ROM, authentication data including a public key Kpub-Sn of the portable storage medium (Sn), a private key Kpri-Sn, and a public key certificate CertSn. On the other hand, the anycast address setting apparatus (W) stores a public key Kpub-W, a private key Kpri-W, and a public key certificate CertW.

Referring to FIG. 7, the anycast address setting apparatus generates a random number Rb and transmits it to the portable storage medium. The portable storage medium generates random numbers Ra and Ka and calculates Va by multiplying Ka by G which is a base point on an elliptic curve (used in common in the system) employed in the public-key cryptography. Furthermore, the portable storage medium writes a digital signature on data Ra||Rb||Va using the private key (KPri-Sn) of the portable storage medium. The portable storage medium then transmits the public key certificate (CertSn) and other data (CertSn||Ra||Rb||Va together with the digital signature to the anycast address setting apparatus. The digital signature can be generated using a known technique such as a message digest method which uses a combination of RSA cryptography and a hash function SHA-1.

The anycast address setting apparatus checks whether the public key certificate (CertSn) and the digital signature received from the portable storage medium are valid. If the public key certificate (CertSn) and the digital signature are determined to be valid, the anycast address setting apparatus generates a random number Kb and transmits, to the portable storage medium, the public key certificate and other data (CertW||Rb||Ra||Vb) together with a digital signature written on data Rb||Ra||Vb using the private key (KPri-W) of the anycast address setting apparatus.

Upon receiving the data, the portable storage medium checks whether the public key certificate (CertW) and the digital signature received from the anycast address setting apparatus are valid. If they are determined to be valid, the portable storage medium obtains a session key by multiplying Ka by Vb. Similarly, the anycast address setting apparatus obtains the session key Ks by multiplying Kb by Va. If mutual authentication is established between the anycast address setting apparatus and the portable storage medium via the above-described process, communication is performed between them using the session key Ks as an encryption key used in common by them.

Referring back to FIG. 6, the new anycast address issuing sequence is further described. If the anycast address setting apparatus and the portable storage medium are both determined to be authorized devices via the mutual authentication process described above with reference to FIG. 7, the anycast address setting apparatus generates anycast address information (AI) and writes, using the private key Kpri-W of the anycast address setting apparatus, a digital signature on the generated anycast address information (AI). Thereafter, the anycast address setting apparatus decrypts the anycast address information (AI) and the digital signature, using the public key Kpub-Sn of the portable storage medium, which was received from the portable storage medium during the authentication process. The decrypted data is transmitted to the portable storage medium. Although in this specific example, the public key of the receiving device is used as the encryption key in the data communication between the anycast address setting apparatus and the portable storage medium, the data to be transmitted may be encrypted using the common session key obtained in the mutual authentication process using the public key cryptography.

If the portable storage medium receives the encrypted anycast address information, the portable storage medium decrypts the received data using the private key Kpri-Sn of the portable storage medium. The portable storage medium then determines whether or not the anycast address information has been tampered with, by verifying the digital signature attached to the anycast address information by applying the public key Kpub-W of the anycast address setting apparatus. Although in this specific example, the digital signature is generated using the private key of the anycast address setting apparatus, the digital signature may be generated using a private key of an ID issuer. In this case, a public key of the ID issuer is stored in the portable storage medium so that the portable storage medium can verify the digital signature using the public key of the ID issuer.

If the portable storage medium determines, through the verification of the digital signature, that no tampering is made on the anycast address information, the portable storage medium stores, under the control of the CPU 320 shown in FIG. 3, the anycast address information including the digital signature into the interface ID storage memory 324. Thereafter, the portable storage medium transmits an acknowledgment message to the anycast address setting apparatus. When the acknowledgment message is received by the anycast address setting apparatus, the entire process is completed.

(2) Moving of an Anycast Address Between Different Portable Storage Media via an Anycast Address Setting Apparatus

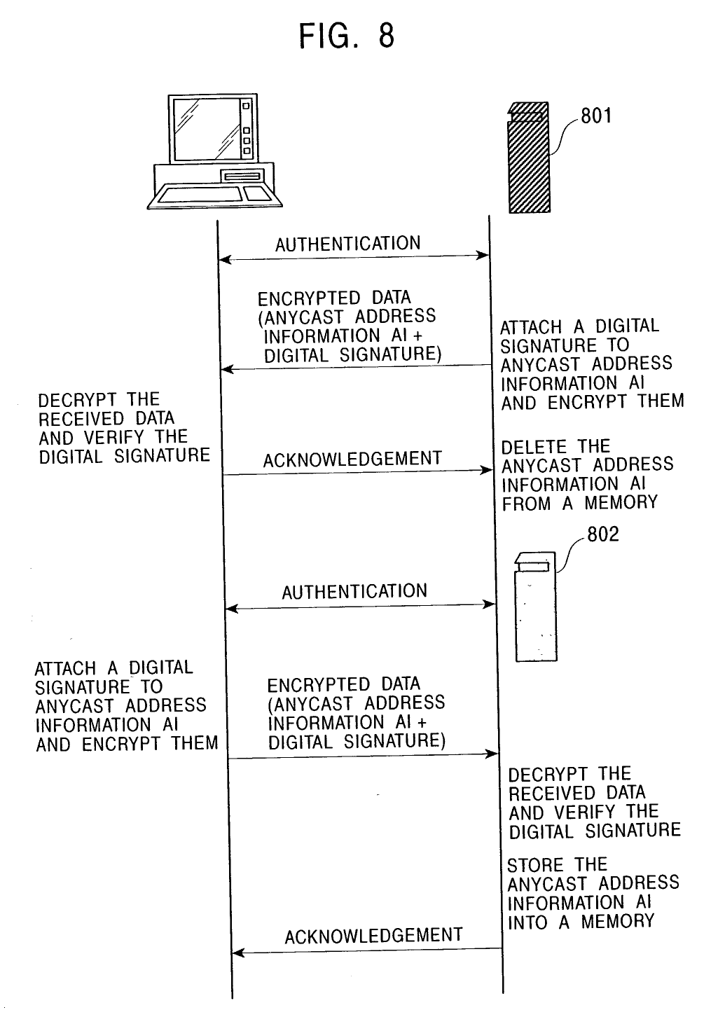

Moving of an anycast address between different portable storage media via an anycast address setting apparatus is described below with reference to FIG. 8.

In the operation of moving an anycast address between different portable storage media, an address-outputting portable storage medium 801 from which an anycast address which is no longer used is to be output and an address-receiving portable storage medium 802 to which the anycast address is to be stored in order to start using it are connected, one after another, to the anycast address setting apparatus.

In the memory (interface ID storage memory 324 shown in FIG. 3) of the address-outputting portable storage medium 801, anycast address information including a digital signature is retained.

First, the address-outputting portable storage medium 801, which wants to output the anycast address which is no longer used, is connected to the anycast address setting apparatus, and mutual authentication is performed. As described earlier, the authentication process can be accomplished using a public key authentication method, a common key authentication method, a combination of a digital watermark and Kerberos which is widely used in IPv4-based systems, or a method implemented on the basis of design according to interface specifications proposed by the Secure Digital Music Initiative (SDMI).

If the mutual authentication process indicates that the portable storage medium 801 and the anycast address setting apparatus are both authorized devices, the address-outputting portable storage medium 801 reads the anycast address information from the memory of the address-outputting portable storage medium 801 and generates a digital signature using a private key of the address-outputting portable storage medium 801. The address-outputting portable storage medium 801 then encrypts data to be transmitted, using a session key or a public key of the anycast address setting apparatus to which the data is to be transmitted. The address-outputting portable storage medium 801 transmits the encrypted data of the anycast address information including the digital signature to the anycast address setting apparatus.

If the anycast address setting apparatus receives the encrypted anycast address information from the address-outputting portable storage medium 801, the anycast address setting apparatus decrypts the received data, using the session key or the private key of the anycast address setting apparatus. Thereafter, to determine whether or not the data has been tampered with, the anycast address setting apparatus verifies the digital signature by applying the public key of the address-outputting portable storage medium 801. Furthermore, the anycast address setting apparatus performs attribute verification.

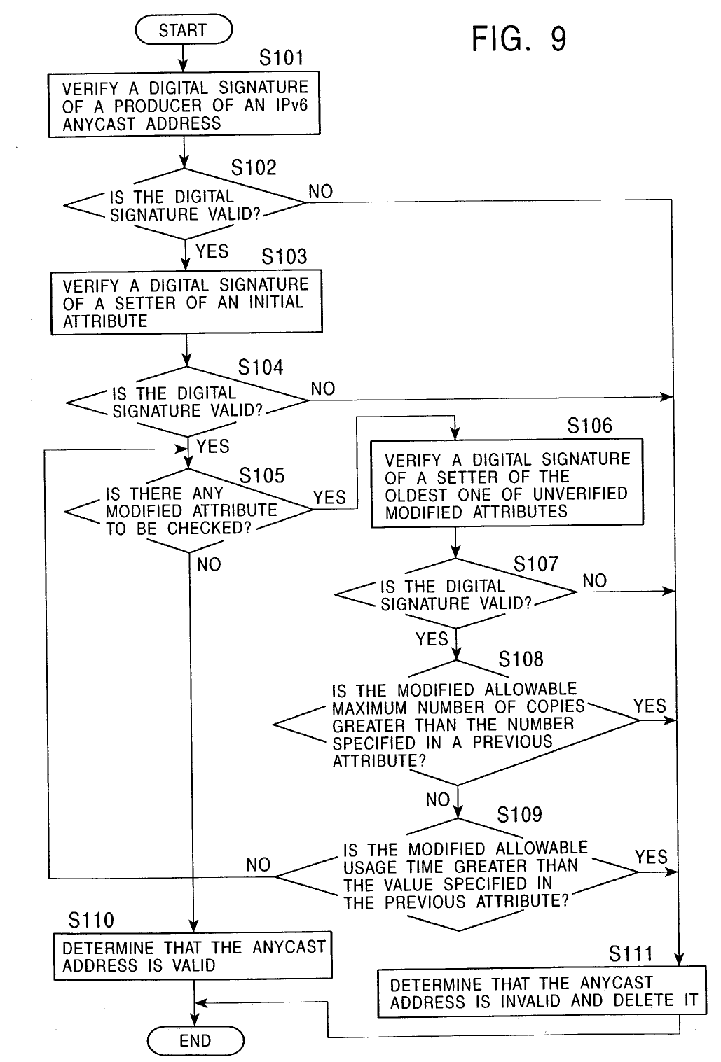

The procedure of the digital signature verification and the procedure of the attribute verification are described below with reference to FIG. 9. If a receiving device, which is to perform the digital signature verification and the attribute verification, receives anycast address information, the receiving device first performs step S101 to verify the digital signature associated with an anycast address (AA, in FIG. 5). It is assumed that a device which performs the verification has already obtained a public key of a producer of the anycast address. If it is determined in step S102 that the verification of the digital signature is not successful, it is determined that the anycast address AA has been tampered with. In this case, the process jumps to step S111 to perform a process for disabling the anycast address from being used. More specifically, for example, an address delete command is transmitted to the portable storage medium, and the anycast address is deleted in response to the command.

In a case in which it is determined in step S102 that the process performed in step S101 to verify the digital signature associated with the anycast address AA indicates that no the data has not been tampered with, (that is, if the answer of decision step S102 is “yes”), the process proceeds to step S103 to check the validity of a digital signature associated with an initial attribute (AT1, in FIG. 5). Also in this case, it is assumed that a device which performs the verification has already obtained a public key. Depending on the situation, the public key used in the verification is or is not the same as that of an issuer of the anycast address information. If it is determined in step S104 that the verification is not successful, it is determined that the initial attribute AT1 has been tampered with, and the process jumps to step S111 to perform a process for disabling the anycast address from being used. In this specific example, the anycast address is deleted.

In the next step S105, it is checked whether there is a modified attribute to be verified. As described earlier, when attributes are modified in response to copying or using of the anycast address AA, modified attributes AT2, AT3, . . . , and so on are added one after another to the anycast address information. Each modified attribute is added to the anycast address information together with a digital signature generated by a device (the user terminal, the portable storage medium, or the anycast address setting apparatus) which has made a modification. Thus, in step S105, it is determined whether the anycast address information includes such a modified attribute. If there is no such modified attribute, the verification of digital signatures is completed, and thus the process proceeds to step S110 in which the anycast address information is determined to be valid and the entire process is completed.

In a case in which there is a modified attribute, the process proceeds to step S106 to verify a digital signature associated with an unchecked modified attribute. Attributes are read and verified in the order of the modification date/time (in the same order as the modified attributes were added). The verification is performed in terms of: 1) whether the digital signature is valid (S107), 2) whether the maximum allowable number of copies has been increased (S108), and 3) whether the available usage time has been increased (S109). In this specific example, the maximum allowable number of copies and the available usage time are checked to decrease them as the anycast address is used. If another attribute is essential in an application, such an attribute is checked. All items of attributes are checked in the same order as they were modified. If the verification has been passed for all items described above, the verification process is ended. However, the verification fails for one or more items, the process jumps to step S111 to disable the anycast address information from being used by performing a proper process. In this specific embodiment, the anycast address information is deleted.

Referring back to FIG. 8, the sequence of processing steps of moving the anycast address between different portable storage media is further described. If the data is proved to be valid by the verification of the digital signature of the anycast address information received from the address-outputting portable storage medium 801, the anycast address setting apparatus transmits an acknowledgment message to the address-outputting portable storage medium 801. In response to receiving the acknowledgment message, the address-outputting portable storage medium 801 deletes the anycast address.

Thereafter, an address-receiving portable storage medium 802 is connected to the anycast address setting apparatus. After connecting them, authentication is performed to check whether the portable storage medium and the anycast address setting apparatus are both authorized devices. The authentication process can be accomplished using a public key authentication method, a common key authentication method, a combination of a digital watermark and Kerberos which is widely used in IPv4-based systems, or a method implemented on the basis of design according to interface specifications proposed by the Secure Digital Music Initiative (SDMI).

If the anycast address setting apparatus and the portable storage medium are both determined to be authorized devices via the mutual authentication process described above with reference to FIG. 7, the anycast address setting apparatus writes, using the private key Kpri-W of the anycast address setting apparatus, a digital signature on the anycast address information received from the address-outputting portable storage medium 801 and encrypts the anycast address information and the digital signature, using the public key Kpub-Sn of the portable storage medium acquired in the mutual authentication process. The encrypted data is transmitted to the address-receiving portable storage medium 802. Although in this specific example, the public key of the receiving device is used as the encryption key in the data communication between the anycast address setting apparatus and the portable storage medium, the data transmitted may be encrypted using the common session key obtained in the mutual authentication process using the public key cryptography.

If the address-receiving portable storage medium 802 receives the encrypted anycast address information, the address-receiving portable storage medium decrypts the received data using the private key Kpri-Sn of the address-receiving portable storage medium. The address-receiving portable storage medium then determines whether or not the anycast address information has been tampered with, by verifying the digital signature attached to the anycast address information by applying the public key Kpub-W of the anycast address setting apparatus. Although in this specific example, the digital signature is generated using the private key of the anycast address setting apparatus, the digital signature may be generated using a private key of an ID issuer. In this case, a public key of the ID issuer is stored in the portable storage medium so that the portable storage medium can verify the digital signature using the public key of the ID issuer.

If the portable storage medium determines, through the verification of the digital signature, that anycast address information has not been tampered with, the portable storage medium stores, under the control of the CPU 320 shown in FIG. 3, the anycast address information including the digital signature into the interface ID storage memory 324. Thereafter, the portable storage medium transmits an acknowledgment message to the anycast address setting apparatus. When the acknowledgment message is received by the anycast address setting apparatus, the entire process is completed.

(3) Copying of an Anycast Address Between Different Portable Storage Media via an Anycast Address Setting Apparatus.

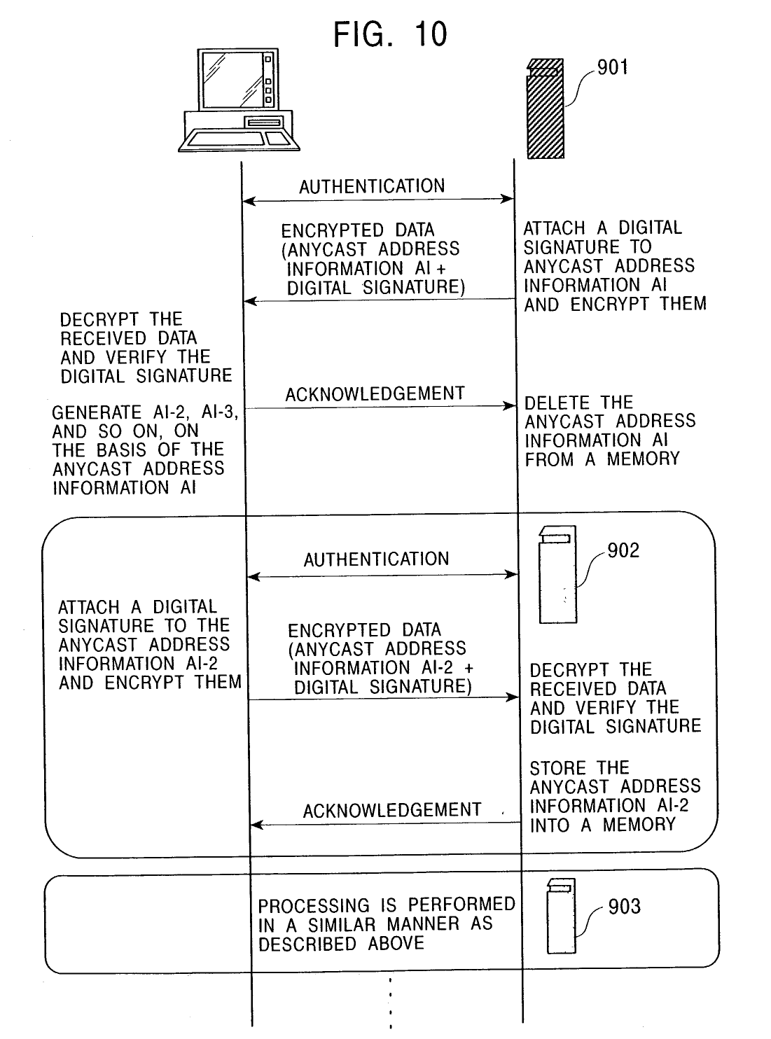

Copying of an anycast address between different portable storage media via an anycast address setting apparatus is described below with reference to FIG. 10. In the copying process, an copy-source portable storage medium 901 from which an anycast address is to be copied, and copy-destination portable storage media 902, 903, . . . , and so on to which the anycast address is to be copied are connected, one after another, to the anycast address setting apparatus.

In the memory (interface ID storage memory 324 shown in FIG. 3) of the copysource portable storage medium 901, anycast address information including a digital signature is retained.

First, the copy-source portable storage medium 901, from which the anycast address is to be copied, is connected to the anycast address setting apparatus, and mutual authentication is performed. If the mutual authentication process indicates that the portable storage medium 901 and the anycast address setting apparatus are both authorized devices, the copy-source portable storage medium 901 reads the anycast address information from the memory of the copy-source portable storage medium 901 and generates a digital signature using a private key of the copy-source portable storage medium 901. The copy-source portable storage medium 901 then encrypts data to be transmitted, using a session key or a public key of the anycast address setting apparatus to which the data is to be transmitted. The copy-source portable storage medium 901 transmits the encrypted data of the anycast address information including the digital signature to the anycast address setting apparatus.

If the anycast address setting apparatus receives the encrypted anycast address information from the copy-source portable storage medium 901, the anycast address setting apparatus decrypts the received data, using the session key or the private key of the anycast address setting apparatus. Thereafter, to determine whether or not tampering has been made on the data, the anycast address setting apparatus verifies the digital signature by applying the public key of the copy-source portable storage medium 901.

If the data is proved to be valid by the verification of the digital signature of the anycast address information received from the copy-source portable storage medium 901, the anycast address setting apparatus transmits an acknowledgment message to the copy-source portable storage medium 901. Furthermore, copies AI-1 and AI-2 are generated on the basis of the anycast address information which was received and has been proved to be valid. If the copy-source portable storage medium 901 receives the acknowledgment message, the copy-source portable storage medium 901 deletes the anycast address information (AI) from the memory 324.

A modified attribute is added (together with a digital signature) to the copied anycast address information (AI-n). The copying is controlled such that the cumulative number of times the anycast address is copied does not exceed the value of the maximum allowable number of copies described in the original anycast address information from which copies are made. Thus, a number of copies of anycast address information, AI-1, AI-2, and so on are obtained.

Thereafter, a copy-destination portable storage medium 902 is connected to the anycast address setting apparatus. If the anycast address setting apparatus and the copy-destination portable storage medium 902 are both determined to be authorized devices via the mutual authentication process, the anycast address setting apparatus writes a digital signature on the copied anycast address (AI-2), using a private key Kpri-W of the anycast address setting apparatus or using a session key. Furthermore, the anycast address setting apparatus encrypts them using a public key, acquired in the authentication process, of the copy-destination portable storage medium 902 and transmits the encrypted data to the copy-destination portable storage medium 902.

If the copy-destination portable storage medium 902 receives the encrypted anycast address information, the copy-destination portable storage medium 902 decrypts the received data using the private key of the destination portable storage medium. The copy-destination portable storage medium then determines whether or not the anycast address information has been tampered with, by verifying the digital signature attached to the anycast address information by applying the public key Kpub-W of the anycast address setting apparatus. If it is determined, through the verification of the digital signature, that no tampering is made on the anycast address information, the copy-destination portable storage medium 902 stores, under the control of the CPU 320 shown in FIG. 3, the anycast address information including the digital signature into the interface ID storage memory 324. Thereafter, the copy-destination portable storage medium 902 transmits an acknowledgment message to the anycast address setting apparatus.

Another copy-destination portable storage medium 903 is then connected to the anycast address setting apparatus, and the above-described process is repeated. The copying process is performed as many times as there are portable storage media to which the anycast address information is to be copied.

(4) Usage of an Anycast Address

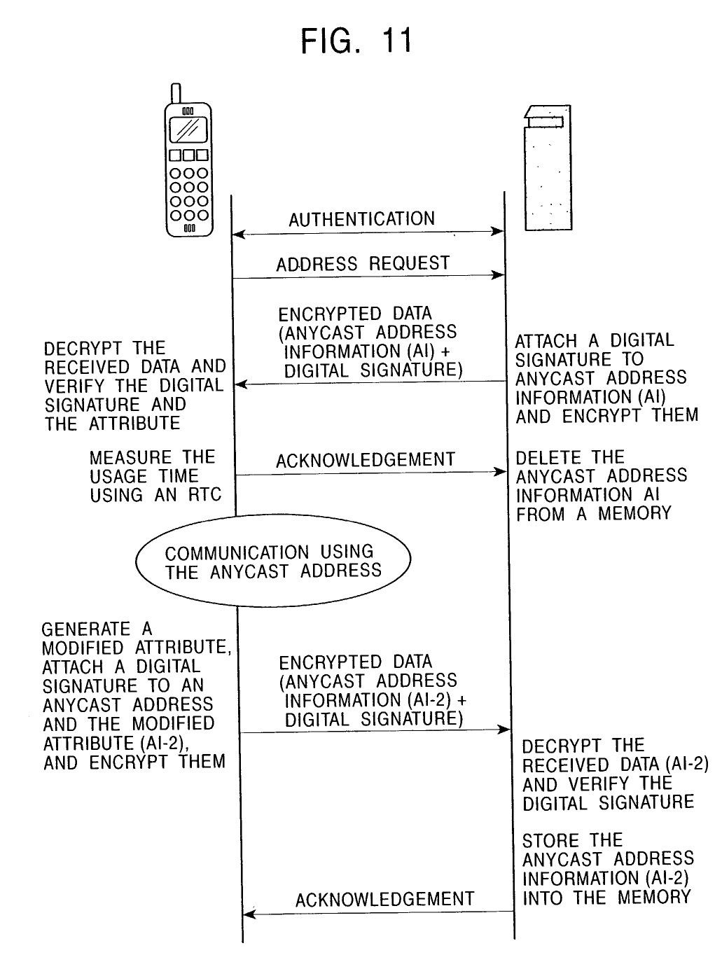

A process of using an anycast address is described below with reference to FIG. 11. When a user actually performs IPv6-based communication, an anycast address is temporarily transferred from a portable storage medium to a user terminal serving as a communication terminal. Herein, the transferring of the anycast address is temporary in the sense that the anycast address is transferred to the user terminal from the portable storage medium only when an IPv6-based communication is performed, the anycast address is deleted from the portable storage medium, and the anycast address is returned together with a modified attribute generated depending on the usage condition to the portable storage medium after the IPv6-based communication is completed. This prevents the same anycast address information from being unexpectedly used at the same time.

Referring to FIG. 11, the process of using an anycast address is described in further detail. A memory (an interface ID storage memory 324 shown in FIG. 3) of a portable storage medium serves as an anycast address supply device and retains anycast address information including a digital signature attached thereto. The portable storage medium is connected to a user terminal serving as a communication terminal via a communication plug and a communication socket such that data can be transmitted between them.

First, mutual authentication is performed between the portable storage medium serving as the anycast address supply device and the communication terminal serving as an anycast address usage terminal. If the mutual authentication process indicates that the portable storage medium and the communication terminal are both authorized devices, the communication terminal transmits an address transfer request to the portable storage medium. The portable storage medium reads the anycast address information from the memory of the portable storage medium and generates a digital signature using a private key of the portable storage medium. The portable storage medium then encrypts data to be transmitted, using a session key or a public key of the communication terminal to which the data is to be transmitted, and the portable storage medium transmits the encrypted data of the anycast address information including the digital signature to the communication terminal.

If the communication terminal receives the encrypted anycast address information from the portable storage medium, the communication terminal decrypts the received data, using a session key or a private key of the communication terminal. Thereafter, to determine whether the data has been tampered with, the communication terminal verifies the digital signature by applying the public key of the portable storage medium from which the anycast address information has been received.

Furthermore, the communication terminal checks attributes included in the anycast address information received from the portable storage medium to verify the maximum allowable number of copies and the available usage time. The checking is performed in a similar manner as is performed in step S108 or S109 described above with reference to FIG. 9. If the received data is determined to be valid, the communication terminal transmits an acknowledgment message to the portable storage medium. In response to receiving the acknowledgment message, the portable storage medium deletes the anycast address.

The communication terminal stores the anycast address information received from the portable storage medium into the memory (the interface ID storage memory 318 shown in FIG. 3) of the communication terminal, and starts a communication process using the stored anycast address as the anycast address of the communication terminal. If the usage time is restricted as is the case with IPv6 anycast addresses, the usage time is measured using, for example, an RTC.

When the communication process is completed, a modified attribute is generated in accordance with the measured usage time, and a digital signature generated using the private key of the communication terminal is attached to the modified attribute. Thereafter, the communication terminal encrypts the anycast address information including the modified attribute, using the public key of the portable storage medium, and transmits the encrypted data to the portable storage medium.

Upon receiving the anycast address information, the portable storage medium decrypts the received data using the private key of the portable storage medium. The portable storage medium then determines whether or not the anycast address information has been tampered with, by verifying the digital signature attached to the anycast address information by applying the public key of the communication terminal. If the verification of the digital signature indicates that no tampering is made on the anycast address information, the portable storage medium stores, under the control of the CPU 320 shown in FIG. 3, the anycast address information including the digital signature into the interface ID storage memory 324. Thereafter, the portable storage medium transmits an acknowledgment message to the communication terminal, and the entire process is completed.

As described above, each time the anycast address is used by the communication terminal, a modified attribute is added one after another to the anycast address information stored in the portable storage medium.

(5) Returning (Taking-back) of an Anycast Address

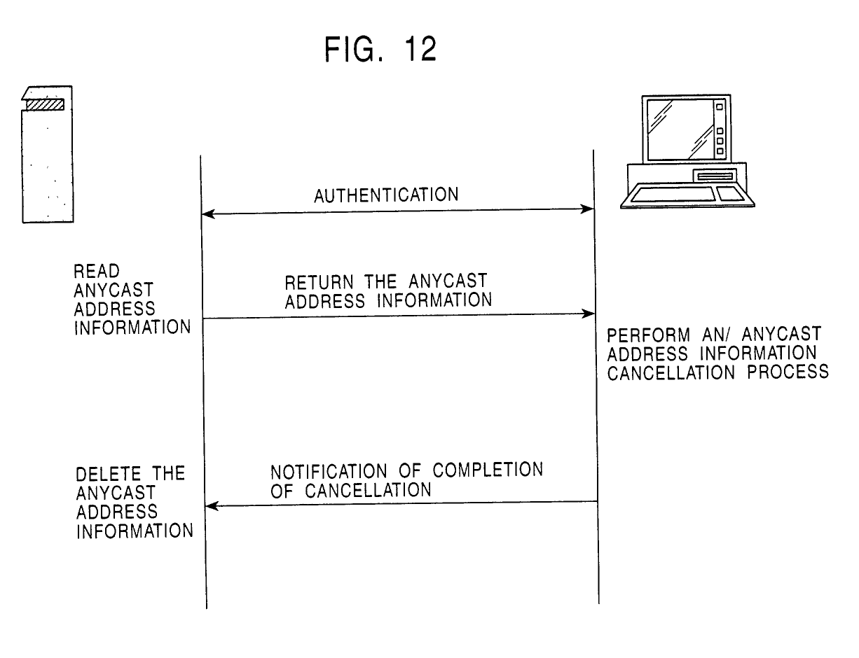

A process of returning (taking back) an anycast address is described in detail below. FIG. 12 shows a sequence of processing steps of returning (taking back) an anycast address. Herein, it is assumed that an anycast address is returned from a portable storage medium.

The portable storage medium retains anycast address information including a digital signature attached thereto. The portable storage medium from which an anycast address is to be returned is connected to an anycast address setting apparatus, and mutual authentication is performed.

If the mutual authentication process indicates that the portable storage medium and the anycast address setting apparatus are both authorized devices, the portable storage medium reads the anycast address information from its memory and transmits it to the anycast address setting apparatus. If the anycast address setting apparatus receives the anycast address from the portable storage medium, the anycast address setting apparatus cancels the anycast address by deleting corresponding data from the anycast address management database upon the verification of a digital signature attached to the anycast address information where the verified digital signature indicates that no tampering is made on the anycast address. More specifically, data indicating the correspondence between a user and the anycast address and data indicating periods of validity are deleted from the anycast address management database, which is a database used to manage issuing of anycast addresses.

Thereafter, the anycast address setting apparatus notifies the portable storage medium that an anycast address cancellation process has been completed. Upon receiving the completion notification, the portable storage medium deletes the anycast address from the memory of the portable storage medium.

Note that a number of anycast addresses can be stored in a single portable storage medium, if necessary. For example, a number of anycast addresses may be stored in a single portable storage medium so that different services such as an anycast service can be received by one or more IPv6 devices. By storing a number of anycast addresses in a portable storage medium, it is possible to relate various services which may be different in quality or function to the respective anycast addresses. For example, if an anycast address “X” assigned to video telephone application service is stored as an anycast address in a portable storage medium, it becomes possible for a user to receive video telephone service using the anycast address X.

Note that processes disclosed herein in the present description may be executed by a combination of hardware and software. Execution of processes by software may be accomplished by installing a program, in which a sequence of processing steps is described, into a memory disposed in a computer embedded in dedicated hardware, or by installing such a program into a general-purpose computer capable of executing various kinds of processes.

The program may be stored, in advance, in a storage medium such as a hard disk or a Read Only Memory (ROM). Alternatively, the program may be stored (recorded) ,temporarily or permanently on a removable storage medium such as a floppy disk, a Compact Disc Read Only Memory (CD-ROM), an Magneto-optical (MO) disk, a Digital Versatile Disc (DVD), a magnetic disk, or a semiconductor memory. Such a removable recording medium may be provided in the form of so-called package software.

Instead of installing the program from such a removable storage medium onto the computer, the program may also be transferred to the computer from a download site by means of radio transmission or by means of cable transmission via a network such as an Local Area Network (LAN) or the Internet. In this case, if the computer receives the program transmitted in such a manner, the computer installs the program on a storage medium such as a hard disk disposed in the computer. The processes disclosed in the present description may be executed time-sequentially in the same order as processing steps are described in the program, or may be executed in parallel or individually depending on the capacity or capability of an apparatus which executes processes.

As described above, in the address management system and method, and the computer program according to the present invention, an anycast address is supplied via a portable storage medium so that the anycast address can be used by various communication terminals. When a communication terminal is replaced with a new one, the same anycast address can be used for the new communication terminal, and thus IPv6-based communication can be employed in service such as telephone service in which high availability is required. Furthermore, an anycast address can be used as an identifier uniquely identifying a user, and thus this technique provides an infrastructure which is very useful, in particular, in applications in which service is provided differently depending on customers.

Furthermore, an anycast address can be moved, copied, and returned. This makes it possible for a number of users or devices to use the same anycast address in a very efficient manner. In the operation of moving, copying, or returning of an anycast address, high security is achieved using a digital content protection mechanism. The operation of moving, copying, or returning of an anycast address can be performed using an ordinary device adapted to a portable storage medium. This is very convenient for users. Because inputting the anycast address by a user is not required, the anycast address can be distributed easily in a highly reliable manner. This is also very convenient for users.

A number of anycast addresses can be stored in a single portable storage medium, and various kinds of services with different quality and functions can be related to the respective anycast addresses. This makes it possible to realize a high-performance communication terminal capable of performing a number of anycast-based services. This makes the communication terminal very competitive. For example, if an attribute of voice telephone is given to an anycast address A and an attribute of video telephone is given to an anycast address B, the address A can be supplied to a voice terminal and the address B can be supplied to a video telephone terminal using a portable storage medium

The present invention has been described in detail above with reference to particular embodiments. It will be apparent to those skilled in the art that various modifications and substitution to those embodiments may be made in the embodiment chosen for illustration without departing from the spirit and scope of the invention. That is, the embodiments have been described above by way of example and not limitation. The scope of the invention is to be determined solely by the appended claims.

The invention is claimed as follows:

1. An address management system comprising:
a communication terminal in which an address is to be set;
a portable storage medium attached to the communication terminal which stores an anycast address; and
an anycast address setting apparatus for issuing anycast address information associated with the address to be set in the communication terminal;
wherein the anycast address setting apparatus outputs the anycast address information to the portable storage medium when the portable storage medium successfully passes authentication;
wherein upon receiving the anycast address information, the portable storage medium stores the received anycast address information into a memory in the portable storage medium, and outputs the anycast address information to the communication terminal, when authentication is successfully established between the portable storage medium and the communication terminal; and
wherein the communication terminal sets an address included in the anycast address information received from the portable storage medium such that the address functions as an anycast address assigned to the communication terminal.

2. An address management system according to claim 1, wherein the address included in the anycast address information is an interface ID indicated by lower-order bits of an address structure defined in IPv6.

3. An address management system according to claim 1, wherein the anycast address setting apparatus outputs the anycast address information to be stored in the portable storage medium and a digital signature generated by the anycast address setting apparatus when the portable storage medium successfully passes authentication, and when the portable storage medium receives the anycast address information and the digital signature, the portable storage medium stores the anycast address information and the digital signature into the memory in the portable storage medium the verification of the digital signature.

4. An address management system according to claim 1, wherein the anycast address information stored in the portable storage medium includes usage condition information and a digital signature.

5. An address management system according to claim 1, wherein the anycast address information stored in the portable storage medium includes additional attribute information including usage condition information, and generates a modified attribute as updated data when the attribute information changes and stores the modified attribute in the portable storage medium with a digital signature generated by the device which generated the modified attribute.

6. An address management system according to claim 1, wherein the anycast address setting apparatus moves and/or copies anycast address information such that anycast address information received from a first portable storage medium is output to a second portable storage medium.

7. An address management system according to claim 1, wherein the anycast address setting apparatus moves and/or copies an anycast address information such that anycast address information received from a first portable storage medium is output to a second portable storage medium upon the verification of a digital signature attached to the anycast address information received from the first portable storage medium.

8. An address management system according to claim 1, wherein the portable storage medium outputs the anycast address information with a digital signature generated by the portable storage medium to the communication terminal, when authentication is successfully established between the portable storage medium and the communication terminal, and when the communication terminal receives the anycast address information and the digital signature, the communication terminal stores the anycast address information in the memory in the communication terminal such that the anycast address functions as an anycast address of the communication terminal upon the verification of the digital signature.

9. An address management system according to claim 1, wherein the anycast address setting apparatus receives anycast address information with a digital signal from the portable storage medium and cancels the anycast address information by deleting associated data from an anycast address information management database upon the verification of the digital signature.

10. An anycast address setting apparatus for issuing anycast address information associated with an address usable as an address of a communication terminal, comprising parts for outputting anycast address setting apparatus outputs anycast address information to a portable storage medium, which stores the address upon successful authentication between the anycast address setting apparatus and the portable storage medium.

11. An anycast address setting apparatus according to claim 10, wherein the address included in the anycast address information is an interface ID indicated by lower-order bits of an address structure defined in IPv6.

12. An anycast address setting apparatus according to claim 10, wherein a digital signature attaches to the anycast address information when the anycast address setting apparatus outputs anycast address information to the portable storage medium into which the anycast address is to be stored.

13. An anycast address setting apparatus according to claim 10, apparatus outputs anycast address information to the portable storage medium, the anycast address setting apparatus adds, to the anycast address information, attribute information, including usage condition information and a digital signature attached thereto for verifying whether no tampering is made;

14. An anycast address setting apparatus according to claim 10, wherein the anycast address setting apparatus moves and/or copies anycast address information such that anycast address information received from a first portable storage medium is output to a second portable storage medium.

15. An anycast address setting apparatus according to claim 10, wherein the anycast address setting apparatus moves and/or copies anycast address information such that the anycast address information received from a first portable storage medium is output to a second portable storage medium upon verification of a digital signature attached to the anycast address information received from the first portable storage medium.

16. An anycast address setting apparatus according to claim 10, wherein the anycast address setting apparatus receives anycast address information having a digital signal signature from the portable storage medium and cancels the anycast address information by deleting associated data from an anycast address information management database upon verification of the digital signature.

17. A communication terminal for performing a communication process, comprising:
parts for receiving anycast address information from a portable storage medium including an address usable as an address of the communication terminal upon successful authentication between the portable storage medium and the communication terminal; and
a memory for storing the received anycast address information, wherein the address functions as an anycast address of the communication terminal upon verification of a digital signature attached to the anycast address information.

18. A communication terminal according to claim 17, wherein the address included in the anycast address information is an interface ID indicated by lower-order bits of an address structure defined in IPv6.

19. An information storage device attachable and detachable to and from a communication terminal, having a capability of processing data, comprising a memory for storing anycast address information, including an address usable as an address of the communication terminal, wherein the anycast address information is read from the memory of the information storage device and output to the communication terminal upon successful authentication between the information storage device and the communication terminal.

20. An information storage device according to claim 19, wherein the information storage device deletes the anycast address information from the memory of the information storage device after the information storage device reads the anycast address information from the memory and outputs it to the communication terminal.

21. An address management method for managing an address which is set in a communication terminal for performing communication processing, the method comprising the steps of:
outputting anycast address information from an anycast address setting apparatus to a portable storage medium upon successful authentication between the anycast address setting apparatus and the portable storage medium;
storing the received anycast address information into a memory disposed in the portable storage medium;
outputting the anycast address information from the portable storage medium to the communication terminal upon successful authentication between the portable storage medium and the communication terminal; and
setting an address included in the anycast address information received from the portable storage medium such that the address functions as an anycast address of the communication terminal.

22. An address management method according to claim 21, wherein the address included in the anycast address information is an interface ID indicated by lower-order bits of an address structure defined in IPv6.

23. An address management method according to claim 21, the method further including the steps of:
outputting the anycast address information to be stored in the portable storage medium with a digital signature generated by the anycast address setting apparatus upon the successful authentication of the portable storage medium; and
storing the anycast address information and the digital signature into the memory in the portable storage medium upon the verification of the digital signature when the portable storage medium receives the anycast address information and the digital signature.

24. An address management method according to claim 21, wherein the anycast address information stored in the portable storage medium includes additional attribute information including usage condition information and a digital signature.

25. An address management method according to claim 21, wherein the anycast address information stored in the portable storage medium includes additional attribute information including usage condition information, and a modified attribute and a digital signature are generated when the attribute information is changed.

26. An address management method according to claim 21, the method further comprising the steps of moving and/or copying anycast address information such that anycast address information received from a first portable storage medium is output to a second portable storage medium.

27. An address management method according to claim 21, the method further comprising the steps of moving and/or copying an anycast address information received from a first portable storage medium and outputting the anycast information to a second portable storage medium upon the verification of a digital signature attached to anycast address information received from the first portable storage medium.

28. An address management method according to claim 21, the method further comprising the steps of:
outputting the anycast address information with a digital signature generated by the portable storage medium to the communication terminal, upon the successful authentication between the portable storage medium and the communication terminal; and
storing the anycast address information in the memory of the communication terminal when the communication terminal receives the anycast address information and the digital signature such that the anycast address functions as an anycast address of the communication terminal upon verification of the digital signature.

29. An address management method according to claim 21, the method further comprising the steps of:
receiving anycast address information with a digital signature from the portable storage medium; and
canceling the anycast address information by deleting associated data from an anycast address information management database upon the verification of the digital signature.

30. A computer program for causing a computer system to execute an address issuing process for issuing an address to be set in a communication terminal, the computer program comprising the steps of:
performing authentication between an anycast address setting apparatus, which issues anycast address information including an address usable as an address of the communication terminal, and an information storage device into which the address is to be stored;
outputting the anycast address information from the anycast address setting apparatus to the information storage device upon successful authentication;
verifying a digital signature associated with the anycast address information; and
storing the anycast address information into a memory upon the verification of the digital signature.

31. A computer program for causing a computer system to execute a communication process using an address set in a communication terminal, the computer program comprising the steps of:
performing authentication between the communication terminal and a storage medium attached to the communication terminal;
outputting anycast address information from the storage medium to the communication terminals upon successful authentication between the storage medium and the communication terminal; and
setting an address included in the anycast address information received from the storage medium such that the address functions as an anycast address of the communication terminal.
